(19) United States
(12) Patent Application Publication
(10) Pub. No.: US 2026/0077620 A1
(43) Pub. Date: Mar. 19, 2026

(54) NON-PNEUMATIC TIRE ASSEMBLY

(71) Applicant: The Goodyear Tire & Rubber Company, Akron, OH (US)

(72) Inventors: Wesley Glenn Sigler, Barberton, OH (US); Kurtis Dale Kandel, Louisville, OH (US); Steven Allan Kontney, Indianapolis, IN (US)

(21) Appl. No.: 18/884,810

(22) Filed: Sep. 13, 2024

(51) Int. Cl. B60C 7/14

(52) U.S. Cl. CPC B60C 7/146

(57) ABSTRACT

The present invention is directed to a non-pneumatic tire assembly comprising a radially outer tread band, a radially inner hub portion, and a supporting portion circumferentially supporting the tread band on the hub portion, wherein the supporting portion comprises at least one circumferential row of spokes, extending from a radially outer annular portion of the supporting portion to the radially inner hub portion. The row of spokes further comprises a plurality of radially inwards protruding and axially extending anchoring portions being provided along a circumferential direction, wherein the hub portion has a plurality of axially extending anchoring slots for axially receiving and locking the anchoring portions against movement in a radial direction of the tire assembly. At least one of a radial thickness and a circumferential width of at least one of the anchoring portions and of a respective anchoring slot tapers along an axial direction.

### FIELD OF THE INVENTION

The present invention is directed to a non-pneumatic tire assembly, particularly comprising a circumferential tread portion, a circumferential supporting portion, and a circumferential hub portion.

### BACKGROUND OF THE INVENTION

In some applications, non-pneumatic tires are robust alternatives to pneumatic tires as they do not require tire inflation pressure and are particularly puncture resistant. However, building non-pneumatic tires is typically considerably different from the established production of pneumatic tires. Despite developments in the construction of non-pneumatic tires during the past decade, considerable room for improvement remains, particularly with respect to cost-efficiency and efficient manufacturability.

### SUMMARY OF THE INVENTION

In a first aspect of the present invention, the invention is directed to a non-pneumatic tire assembly comprising a radially outer circumferential tread band, a radially inner circumferential hub portion, and a circumferential supporting portion circumferentially supporting a radially inner side of the circumferential tread band on the circumferential hub portion. The circumferential supporting portion comprises a radially outer annular portion and at least one circumferential row of spokes, extending from the radially outer annular portion to the circumferential hub portion, and comprising a plurality of radially inwards protruding and axially extending anchoring portions provided along a circumferential direction of the tire assembly. The circumferential hub portion has a plurality of axially extending anchoring slots provided on its radially outer side and along the circumferential direction for axially receiving the radially protruding and axially extending anchoring portions and for locking the anchoring portions against movement in a radial direction of the tire assembly. Furthermore, at least one of the anchoring portions has a neck portion and an anchoring head portion, wherein the neck portion is circumferentially narrower than the anchoring head portion, and wherein at least one of the anchoring slots has a neck receiving portion and an anchoring head receiving portion. Still in accordance with the first aspect, at least one of i) a radial thickness and ii) a circumferential width of the anchoring head portion and of the anchoring head receiving portion tapers along the axial direction.

In a second aspect of the present invention, the invention is directed to a non-pneumatic tire assembly comprising a radially outer circumferential tread band, a radially inner circumferential hub portion, and a circumferential supporting portion circumferentially supporting a radially inner side of the circumferential tread band on the circumferential hub portion, wherein the circumferential supporting portion comprises a radially outer annular portion and at least two axially neighboring circumferential rows of spokes, wherein each row of the circumferential rows of spokes extends from the radially outer annular portion to the radially inner circumferential hub portion, and comprises a plurality of radially inwards protruding and axially extending anchoring portions provided along a circumferential direction. Furthermore, the circumferential hub portion has a plurality of axially extending anchoring slots provided on its radially outer side along the circumferential direction for axially receiving the radially protruding and axially extending anchoring portions and locking the anchoring portions against movement in a radial direction of the tire assembly. Still in accordance with the second aspect at least one of the anchoring portions and at least one of the anchoring slots tapers along an axial direction so that an anchoring portion tapering along the axial direction is received in a respective tapering anchoring slot.

In a third aspect of the present invention, the invention is directed to a non-pneumatic tire assembly comprising a radially outer circumferential tread band comprising one or more elastomer compositions, a radially inner circumferential hub portion, and a circumferential supporting portion circumferentially supporting a radially inner side of the circumferential tread band on the radially inner circumferential hub portion, wherein the circumferential supporting portion comprises a radially outer annular portion and at least four circumferential rows of spokes comprising one or more polymer compositions. The circumferential rows of spokes comprise a first circumferential row of spokes provided radially below a first circumferential shoulder portion of the tread band, a second row of spokes provided radially below a second circumferential shoulder portion of the tread band, which is axially opposite to the first circumferential shoulder portion, a third row of spokes provided axially adjacent and inwards the first row of spokes, and a fourth row of spokes provided axially adjacent and inwards the second row of spokes. Furthermore, each row of the circumferential rows of spokes extends from the radially outer annular portion to the radially inner circumferential hub portion, and comprises a plurality of radially inwards protruding and axially extending anchoring portions provided along a circumferential direction. Moreover, the radially inner hub portion has a plurality of axially extending anchoring slots, provided on its radially outer side along the circumferential direction, for axially receiving the anchoring portions and locking the anchoring portions against movement in a radial direction of the tire assembly, and wherein each of the anchoring portions tapers along an axial direction and each of the anchoring slots tapers along the axial direction to complementarily receive a respective tapering anchoring portion. Still in accordance with the third aspect, axially adjacent anchoring portions of the first row of spokes and the third row of spokes taper continuously from the third row of spokes to the first row of spokes along the axial direction in a first axial orientation. Axially adjacent anchoring portions of the fourth row of spokes and second row of spokes taper continuously from the fourth row of spokes to the second row of spokes along the axial direction in a second axial orientation being opposite to the first axial orientation.

### BRIEF DESCRIPTION OF THE DRAWINGS

The invention will be described by way of example and with reference to the accompanying drawings in which:

FIG. 1 is a schematic partially transparent sideview of a non-pneumatic tire assembly according to an embodiment of the present invention;

FIG. 2 is a schematic enlarged view of a portion of the non-pneumatic tire assembly already shown in FIG. 1;

FIG. 3 is a schematic perspective view of the supporting portion and the tread band of the non-pneumatic tire assembly already shown in FIGS. 1 and 2;

FIG. 4 is a schematic partial cut view perpendicular to an equatorial plane of the non-pneumatic tire assembly already shown in FIGS. 1 to 3, particularly showing tapering radial thicknesses of anchoring head portions;

FIG. 5 is a schematic partial perspective view in a radially outer direction of the supporting portion and the tread band already shown in FIG. 3, particularly visualizing tapering circumferential widths of anchoring portions;

FIG. 6 is a schematic partial perspective view of a hub portion of the non-pneumatic tire assembly, as e.g. shown in FIG. 1, showing two axially adjacent radially outer annular portions comprising radially and circumferentially tapering, axially extending slots for receiving anchoring portions; and

FIG. 7 is a schematic side view of an alternative circumferential supporting portion carrying a circumferential tread band, wherein each of the X-shapes spokes of the supporting portion comprises on a radially inner side of its legs an individual anchoring portion.

### DETAILED DESCRIPTION OF THE INVENTION

According to the first aspect, the invention is directed to a non-pneumatic tire assembly comprising a radially outer circumferential tread band, a radially inner circumferential hub portion, and a circumferential supporting portion circumferentially supporting a radially inner side of the circumferential tread band on the radially inner circumferential hub portion, wherein the circumferential supporting portion comprises a radially outer annular (and/or circumferential) portion and at least one circumferential row of spokes, extending from the radially outer annular portion to the radially inner hub portion, and comprising a plurality of radially inwards protruding and axially extending anchoring portions provided along a circumferential direction of the tire assembly. The radially inner circumferential hub portion has a plurality of axially extending anchoring slots provided on its radially outer side (or surface) along the circumferential direction for axially receiving the radially (inwards) protruding and axially extending anchoring portions and locking the anchoring portions against movement in a radial direction of the tire assembly. Preferably, the anchoring portions mechanically interlock with the anchoring slots provided in the radially inner hub portion. Furthermore, at least one of the anchoring portions has a neck portion (or neck) and an anchoring head portion (or anchoring head), wherein the neck portion is circumferentially narrower than the anchoring head portion (and optionally provided radially between the anchoring head portion and an adjacent spoke), and wherein at least one of the anchoring slots has a neck receiving portion (preferably at a radially outer opening of the slot and/or for receiving the neck portion) and an anchoring head receiving portion (preferably adjacent a radially inner bottom of the slot and/or for receiving the anchoring head portion). Still in accordance with the first aspect, at least one of i) a radial thickness and ii) a circumferential width of the anchoring head portion and of the anchoring head receiving portion tapers along the axial direction, such as to matingly receive the anchoring head portion in the anchoring head receiving portion.

Thus, the at least one of the radial thickness and the circumferential width of the anchoring head portion and the corresponding at least one of the radial thickness and the circumferential width of the respective receiving portion tapers along the axial direction, which eases assembly of the hub portion and the row of spokes. Moreover, the taper along the axial direction helps to block relative movement of the row of spokes in at least one axial orientation. Furthermore, the taper also allows to press anchoring portions into the anchoring slots which helps to block movement in either axial orientation after the tapering anchoring portions have been pressed into the tapering anchoring slots. Another advantage of providing such a taper consists in easier manufacturing of the anchoring portions, particularly when demolding such structures from a mold.

In one embodiment, the radial thickness and the circumferential width of the anchoring head portion and of the anchoring head receiving portion taper along the axial direction. Such a taper in both, the radial thickness and the circumferential width allows an even easier assembly. Another effect is an even easier demolding during manufacturing of the anchoring portion and/or the anchoring slots.

In another embodiment, the anchoring head portion is axially received in the anchoring head receiving portion via an interference fit. An interference fit is another preferred embodiment which helps to provide an additional locking against movement in an axial direction, particularly axially oppositely oriented to the taper of the anchoring head portion and/or the anchoring head receiving portion. For instance, the anchoring head portion may comprise a polymer composition, such as one of an elastomer composition, a rubber composition, and a thermoplastic polymer composition. An interference fit may, e.g., be achieved by providing an axially shorter anchoring portion with respect to an axial length of the slot such that axial pressing the anchoring portion into the anchoring slot results in the interference fit. In another option, the anchoring head portion has about the same length as the anchoring head receiving portion but one or more of its radial thickness and its circumferential width is at least 0.001 mm larger (or, optionally, from 0.001 mm to 0.05 mm larger) than the corresponding radial thickness (or diameter) and circumferential width of the anchoring head receiving portion of the slot.

In still another embodiment, each spoke comprises one or more legs, wherein each of the one or more legs preferably comprises one of the anchoring portions at a radially inner side of the respective leg.

In still another embodiment, each spoke has a pair of radially inner legs, wherein preferably, the legs of the pair of radially inner legs are devoid of a circumferential connection adjacent their anchoring portions and/or at the radially inner side of the legs of the pair of radially inner legs.

In still another embodiment, the tread band comprises elastomer compositions, preferably rubber compositions. In addition, or alternatively, one or more of the radially outer annular portion, the rows of the spokes, and the radially inner hub portion comprise one or more polymer compositions. One or more of these polymer compositions are optionally cord and/or fiber reinforced.

In still another embodiment, the radially outer annular portion of the supporting portion is connected to the tread band by one of curing, co-curing, and an adhesive. In particular, co-curing is preferred. In this context, the adjacent tread band typically comprises a rubber composition at its interface with the supporting portion and the supporting portion preferably comprises one of an elastomer composition (e.g., a rubber composition) and a thermoplastic elastomer composition.

In still another embodiment, the non-pneumatic tire assembly comprises a non-pneumatic tire comprising the tread band and the supporting portion. Optionally, the hub portion of the non-pneumatic tire assembly is a rim portion or comprised therein.

In still another embodiment, the radially outer circumferential tread band is a radially outer circumferential annular tread band.

In still another embodiment, each of the spokes has essentially an X-shape, in a plane and/or cross-section perpendicular to an axial direction of the tire assembly, preferably having two radially outer legs and two radially inner legs (and optionally a connecting portion connecting the two radially outer legs and the two radially inner legs radially between the two radially inner legs and the radially outer legs), and wherein each of the two radially inner legs optionally has an integrally formed anchoring portion, which is preferably separate from the anchoring portion of another leg of the two radially inner legs. Optionally, two radially inner legs can be described as a pair of radially inner legs, and/or two radially outer legs can be described as a pair of radially outer legs.

According to the second aspect, the invention is directed to a non-pneumatic tire assembly comprising a radially outer circumferential tread band, a radially inner circumferential hub portion, and a circumferential supporting portion circumferentially supporting a radially inner side of the circumferential tread band on the radially inner circumferential hub portion, wherein the circumferential supporting portion comprises a radially outer annular portion and at least two axially neighboring circumferential rows of spokes, wherein each row of the circumferential rows of spokes extends from the radially outer annular portion to the radially inner hub portion, and comprises a plurality of radially inwards protruding and axially extending anchoring portions provided along a circumferential direction of the tire assembly. The radially inner hub portion has a plurality of axially extending anchoring slots provided on its radially outer side (or surface) along the circumferential direction for axially receiving the radially inwards protruding and axially extending anchoring portions and for locking the anchoring portions against movement in a radial direction of the tire assembly. Still in accordance with the second aspect, at least one of the anchoring portions and at least one of the anchoring slots tapers along an axial direction so that an anchoring portion (or each of the anchoring portions) tapering along the axial direction is received in a respective tapering anchoring slot.

Thus, in accordance with the second aspect, the tire assembly has at least two axially neighboring circumferential rows of spokes, with a plurality of anchoring portions (optionally comprising neck and head portions as described in accordance with the first aspect), and a circumferential hub portion comprising slots for receiving and/or anchoring the rows of spokes. In other words, the anchoring portions can be described as being mechanically interlocked with the anchoring slots.

In one embodiment, a plurality, preferably at least a majority, or even more preferably, all of the anchoring portions and all of the anchoring slots taper along the axial direction so that the anchoring portions tapering along the axial direction are received in respective / correspondingly tapering anchoring slots. Preferably, all anchoring portions of a row of spokes which taper and all anchoring slots which taper, taper in the same axial orientation.

In still another embodiment, the anchoring portions are anchored in the anchoring slots, or in other words, in corresponding anchoring slots, by mechanical interlocking. Anchoring the anchoring portions in the anchoring slots does not necessarily exclude one or more of additional, curing, co-curing, and adhesive bonding between the anchoring portions and the anchoring slots. However, preferably, an interface of the anchoring portions and the anchoring slots is devoid of a connection by curing, co-curing or adhesive bonding. In other words, preferably, the anchoring portions are axially demountable from the anchoring slots. Preferably, this may even apply in case of an interference fit. For instance, the anchoring portions can be axially removed from the anchoring slots by applying an axial force high enough to overcome the force of the interference fit holding the anchoring portions in the anchoring slots.

In still another embodiment, the anchoring portions are (additionally) held in the anchoring slots via an interference fit, e.g., against axial movement of the anchoring portions out of the anchoring slots.

In still another embodiment, at least a majority of the anchoring portions and at least a majority of the anchoring slots taper along an axial direction so that the anchoring portions tapering along the axial direction are received in respective tapering anchoring slots.

In still another embodiment, each anchoring portion of the majority of anchoring portions has a neck portion and an anchoring head portion, wherein a radial height of the anchoring head portion tapers along the axial direction, and each anchoring slot of the majority of anchoring slots has a neck receiving portion (for receiving the neck portion) and an anchoring head receiving portion (for receiving the anchoring head portion), and wherein, optionally, a radial height of the anchoring head receiving portion tapers along the axial direction so as to axially receive the anchoring head portion having the radial height tapering along the axial direction. In addition, or alternatively, each anchoring portion of the majority of anchoring portions has a neck portion and an anchoring head portion, and each anchoring slot of the majority of anchoring slots has a neck receiving portion (for receiving the neck portion) and an anchoring head receiving portion (for receiving the anchoring head portion), and wherein, optionally, a circumferential width of the anchoring head receiving portion tapers along the axial direction so as to axially receive the anchoring head portion having the circumferential width tapering along the axial direction. Thus, in an option, it is possible that both the radial height and the circumferential width of the anchoring portion, particularly the anchoring head portion taper, e.g., with advantages already mentioned herein above.

In still another embodiment, the circumferential rows of spokes comprise a first circumferential row of spokes with anchoring portions tapering in (or with) a first axial orientation, and a second circumferential row of spokes with anchoring portions tapering in (or with) a second axial orientation which is opposite to the first axial orientation. Preferably, each row tapers from an axially inner position to an axially outer position, or in other words, in a direction away from an equatorial plane of the tire assembly and/or tread band. Such an axially outward taper can help to ease the mounting of the radially inner hub portion to the rows of spokes, e.g., with an axially split hub portion.

In still another embodiment, the tire assembly comprises at least four of the circumferential rows of spokes, comprising a first circumferential row of spokes radially below a first circumferential shoulder portion of the tread band, a second row of spokes radially below a second circumferential shoulder portion of the tread band, which is axially opposite to the first circumferential shoulder portion, a third row of spokes provided axially adjacent and inwards the first row of spokes, and a fourth row of spokes axially adjacent and inwards the second row of spokes. The provision of at least four rows of spokes can help to ease manufacturing of the tire assembly. For instance, it is possible to use spokes (or rows of spokes) used for other tire assembly and/or tread band types having the same axial width or multiples of the axial widths of one row of spokes. In addition, or alternatively, each row of spokes may be easier to manufacture, molded, and/or demolded. Moreover, it is easier to manufacture (such as easier to mold) oppositely oriented tapers of the anchoring portions.

In still another embodiment, the anchoring portions of the first row of spokes and the anchoring portions of the third row of spokes are aligned along the axial direction. In other words, they are provided at the same circumferential position. In addition, or alternatively, the anchoring portions of the second row of spokes and the anchoring portions of the fourth row of spokes are aligned along the axial direction. In other words, they are provided at the same circumferential position. Preferably, axially neighboring anchoring portions of the first and third rows of spokes are inserted into and/or received in one anchoring slot of the hub portion.

In still another embodiment, the anchoring portions of the third row of spokes taper in an axially outer orientation from a first circumferential width to a second circumferential width which is smaller than the first circumferential width and wherein the anchoring portions of the first row of spokes taper in an axially outer orientation from a third circumferential width which is the same as or smaller than the second circumferential width, to a fourth circumferential width which is smaller than the third circumferential width.

In still another embodiment, the anchoring portions of the third row of spokes and the anchoring portions of the first row of spokes are received in a common anchoring slot, preferably having an axial section tapering complementarily to the anchoring portion of the third row of spokes and another axial section tapering complementarily to the anchoring portion of the first row of spokes, optionally with an interference fit.

In still another embodiment, axially neighboring anchoring portions of the fourth row of spokes taper in an axially outer orientation from a first circumferential width to a second circumferential width which is smaller than the first circumferential width and wherein the anchoring portions of the second row of spokes taper in an axially outer orientation from a third circumferential width which is the same as or smaller than the second circumferential width, to a fourth circumferential width which is smaller than the third circumferential width.

In still another embodiment, axially neighboring anchoring portions of the fourth row of spokes and the anchoring portions of the second row of spokes are received in a common anchoring slot, preferably having an axial section tapering complementarily to the anchoring portion of the third row of spokes and another axial section tapering complementarily to the anchoring portion of the first row of spokes, optionally with an interference fit.

In still another embodiment, axially adjacent anchoring portions of the first row of spokes and anchoring portions of the third row of spokes have a circumferential width tapering continuously, e.g. linearly, from the third row of spokes to the first row of spokes along the axial direction. In addition, or alternatively, axially adjacent anchoring portions of the second row of spokes and anchoring portions of the fourth row of spokes have a circumferential width tapering continuously, e.g. linearly, from the fourth row of spokes to the second row of spokes along the axial direction. For instance, this may apply to the radial and/or circumferential taper of anchoring head portions mentioned herein above.

In still another embodiment, the radially inner hub portion comprises a first annular member and a second annular member axially (adjacent), preferably detachably mounted to the first annular member, wherein the first annular member optionally comprises anchoring slots tapering in a first axial orientation, for axially receiving the anchoring portions of the first row of spokes and the third row of spokes; and wherein the second annular member optionally comprises anchoring slots tapering in a second axial orientation opposite to the first axial orientation, for axially receiving the anchoring portions of the second row of spokes and the fourth row of spokes. The provision of such an axially split hub portion (e.g., particularly of at least a radially outer portion of the hub portion) helps to ease assembly of the supporting portion and the hub portion.

In still another embodiment, e.g., in case the tire assembly comprises two axially adjacent rows of spokes, the radially inner hub portion comprises a first annular member and a second annular member axially (adjacent) and detachably mounted to the first annular member, wherein the first annular member optionally comprises (on its radially outer side) anchoring slots tapering in a first axial orientation, for axially receiving the anchoring portions of the first row of spokes; and wherein the second annular member optionally comprises (on its radially outer side) anchoring slots tapering in a second axial orientation opposite to the first axial orientation, for axially receiving the anchoring portions of the second row of spokes.

In still another embodiment, each of the circumferential rows of spokes has from 20 to 200, preferably from 30 to 100, anchoring portions.

In still another embodiment, each anchoring portion tapers along the axial direction with an angle within a range of 0.25° to 10°, or preferably of 0.5° to 5°, or of 1° to 4°. In other words, said angle is determined between both elongated sides of the anchoring portion (e.g., extending transversely to the radial and/or circumferential direction.

In still another embodiment, the tire assembly has from 4 to 8 rows of axially adjacent spokes, preferably from 4 to 6 of such rows.

In still another embodiment, the spokes have essentially an X-shape, in a plane perpendicular to an axis of rotation of the tire assembly and/or tread band.

In still another embodiment, each anchoring portion of the anchoring portions has an elongated shape extending in the axial direction and comprises a neck portion and an anchoring head portion protruding in the radial direction (preferably the radially inner direction), wherein the neck portion is circumferentially narrower than the anchoring head portion, and wherein each anchoring slot is elongated along the axial direction and comprises a neck receiving portion mating the neck portion, and an anchoring head receiving portion mating the anchoring head portion.

In still another embodiment, the anchoring portions comprise one or more of a dovetail shape, a T-shape, and a drop shape, particularly in a plane perpendicular to an axis of rotation of the tire assembly.

In still another embodiment, the tread band comprises one or more of a radially outer circumferential tread portion, and a radially inner circumferential shearband, optionally comprising circumferential and/or radially stacked rubber composition layers. In another option, a plurality of said circumferential rubber composition layers are cord-reinforced rubber composition layers. Circumferential tread bands and/or circumferential shear bands as such are known in the art, particularly in the art of non-pneumatic tires.

In still another embodiment, the radially inner hub portion comprises or consists of one or more of i) one or more polymer compositions (such as thermoplastic polymer compositions, e.g., a thermoplastic polyester elastomer composition), which are optionally cord and/or fiber reinforced, such as by textile fibers or glass fibers, and ii) metal material (such as one or more of aluminum, magnesium, titanium, and steel).

In still another embodiment, one or more elastomer compositions are sulfur-cured rubber compositions. In addition, or alternatively, one or more polymer compositions are one or more of thermoplastic polymer compositions (preferably thermoplastic elastomer compositions, or thermoplastic polyester elastomer compositions) and elastomer compositions.

According to the third aspect, the invention is directed to a non-pneumatic tire assembly comprising a radially outer circumferential tread band comprising one or more elastomer compositions, a radially inner circumferential hub portion (preferably comprising one or more of a polymer composition and a metal), and a circumferential supporting portion circumferentially supporting a radially inner side of the circumferential tread band on the radially inner hub portion, wherein the circumferential supporting portion comprises a radially outer annular portion and at least four circumferential rows of spokes comprising one or more polymer compositions (which are preferably cord and/or fiber reinforced). A first circumferential row of spokes is provided radially below a first circumferential shoulder portion of the tread band, a second row of spokes is provided radially below a second circumferential shoulder portion of the tread band, which is axially opposite to the first circumferential shoulder portion, a third row of spokes is provided axially adjacent and inwards the first row of spokes, and a fourth row of spokes is provided axially adjacent and inwards the second row of spokes. Furthermore, each row of the circumferential rows of spokes extends from the radially outer annular portion to the radially inner hub portion, and comprises a plurality of radially inwards protruding and axially extending anchoring portions provided along a circumferential direction of the tire assembly (and/or tread band). Moreover, the radially inner hub portion has (preferably on a radially outer side or surface) a plurality of axially extending anchoring slots, provided along the circumferential direction, for axially receiving the radially inwards protruding and axially extending anchoring portions and locking the anchoring portions against movement in a radial direction of the tire assembly (such as by mechanical interlocking), and wherein each of the anchoring portions tapers along an axial direction and each of the anchoring slots tapers along the axial direction to complementarily receive a respective tapering anchoring portion. Still in accordance with the third aspect, axially adjacent anchoring portions of the first row of spokes and the third row of spokes taper continuously from the third row of spokes to the first row of spokes along the axial direction in a first axial orientation (such as a first axially outer orientation), and axially adjacent anchoring portions of the fourth row of spokes and second row of spokes taper continuously from the fourth row of spokes to the second row of spokes along the axial direction in a second axial orientation (such as a second axially outer orientation) being opposite to the first axial orientation.

Thus, such a design helps to allow relatively easy manufacturing and/or assembly of the rows of spokes. Moreover, a mechanical interlocking between the radially inner hub portion and the rows of spokes is provided.

In one embodiment, the radially inner hub portion comprises a first annular member and a second annular member axially (adjacent) and detachably mounted to the first annular member, wherein the first annular member optionally comprises on its radially outer surface the anchoring slots tapering in a first axial orientation, for axially receiving the anchoring portions of the first row of spokes and the third row of spokes; and wherein the second annular member optionally comprises on its radially outer surface anchoring slots tapering in a second axial orientation opposite to the first axial orientation, for axially receiving the anchoring portions of the second row of spokes and the fourth row of spokes.

In another embodiment, the radially inner hub portion comprises on at least one axial side, or face side, an annular flange portion covering the anchoring slots. For instance, such a flange portion may be removably axially mounted to the radially inner hub portion, such as via screw connection. Alternatively, the annular flange portion may be integrally formed with the hub portion, such as with one of the first annular member and the second annular member. Preferably, each of the first annular member and the second annular member comprises a circumferential flange portion covering anchoring slots on axially outer sides of the hub portion. Such flange portions can for instance help to avoid intrusion of debris into the interface between anchoring portions and anchoring slots.

In another embodiment, each anchoring portion of the anchoring portions is axially received in a respective anchoring slot via an interference fit.

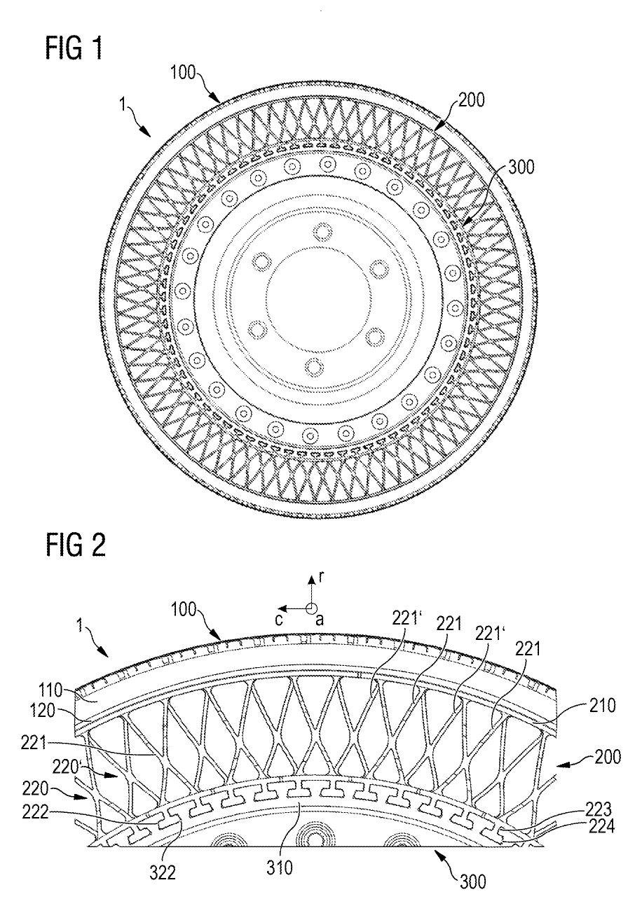

FIG. 1 schematically shows a non-pneumatic tire assembly 1 according to an embodiment of the present invention. The non-pneumatic tire assembly 1 comprises a radially outer circumferential tread band 100, a radially inner circumferential hub portion (or, in other words, rim portion) 300, and a circumferential supporting portion 200, arranged radially between the tread portion 100 and the hub portion 300.

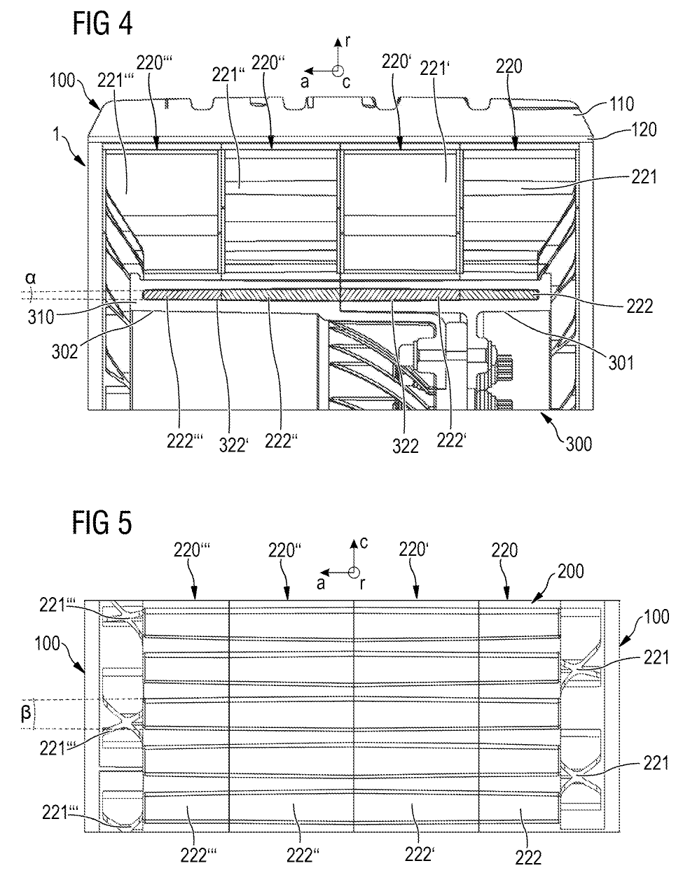

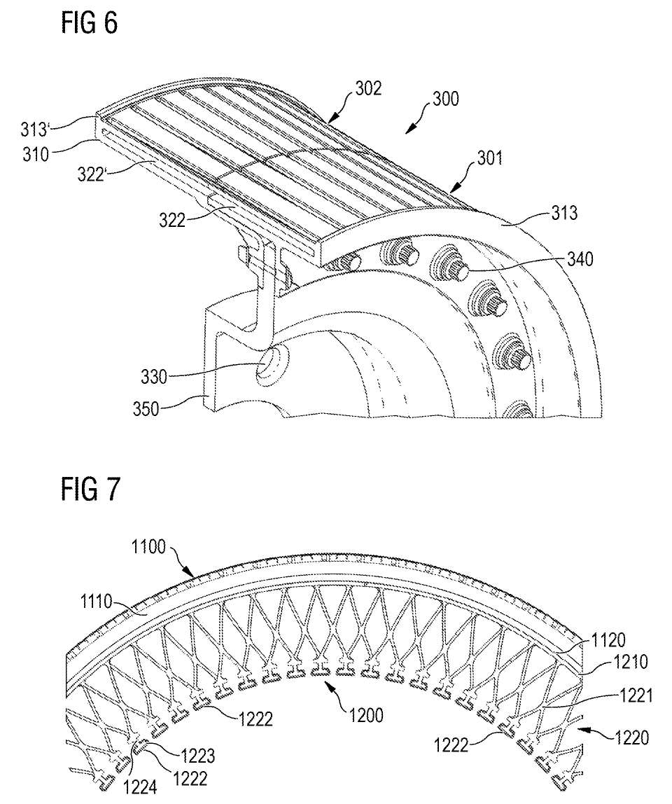

In the enlarged view of FIG. 2, a part of the non-pneumatic tire assembly 1 is shown in further detail, using, where appropriate, the same refence signs as in FIG. 1. The tread band 100 comprises a radially outer circumferential tread band 110 and a radially inner circumferential shearband 120. The hub portion 300 comprises (on its radially outer side or surface) a radially outer circumferential and/or annular portion 310 comprising a plurality of axially extending anchoring slots 322. The supporting portion 200 comprises a radially outer annular portion 210 (which is optionally split in an axial direction as indicated herein further below) and circumferential rows of spokes 220, 220’ (wherein two axially adjacent rows of spokes 220, 220’ are visible in FIG. 2) comprising a plurality of X-shaped spokes 221, 221’. Furthermore, each row of spokes 220, 220’ comprises, on a radially inner side, radially inwards protruding and axially extending (and/or elongated) anchoring portions 222. Each anchoring portion 222 comprises a radially innermost anchoring head portion 224 carried on and/or by a radially inner neck portion 223. Wherein the anchoring head portion 224 preferably protrudes in opposite circumferential orientations away from its neck portion 223. In the present embodiment, the anchoring portions 222 have an essentially T-shaped cross-section in a plane perpendicular to an axis of rotation of the non-pneumatic tire assembly 1. Furthermore, the anchoring slots 322 comprise a corresponding and/or complementary cross-section so as to axially receive an anchoring portion 222 in a respective anchoring slot 322. Such a connection, particularly mechanical interlocking, anchors and/or locks the spokes 221, 221’ and/or the supporting portion 200 in the hub portion 300, particularly against movement in a radial direction of the non-pneumatic tire assembly 1. As described herein above, FIGS. 1 and 2 illustrate anchoring portions received and/or anchored in anchoring slots. Typically, an axially outer side of such slots 322 may be covered by a flange portion, e.g., a circumferential flange portion, such as shown in FIGS. 4 and 6. Such a portion is not shown in FIGS. 1 and 2 for the sake of a better illustration of the mechanical interlocking between the supporting portion 200 and the hub portion 300.

The axial direction a, the circumferential direction c, and the radial direction r are indicated in multiple Figures herein for the sake of better comprehensibility. The axial direction a is parallel to the axis of rotation of the tire assembly (or, in other words of the tire and/or hub portion), the circumferential direction c is perpendicular to the axial direction and parallel to the circumference of the tread band and/or tread portion. Furthermore, the radial direction r is perpendicular to the axial direction a and the circumferential direction c. References to one or more of these directions are not necessarily limited to a specific orientation, unless indicated otherwise herein.

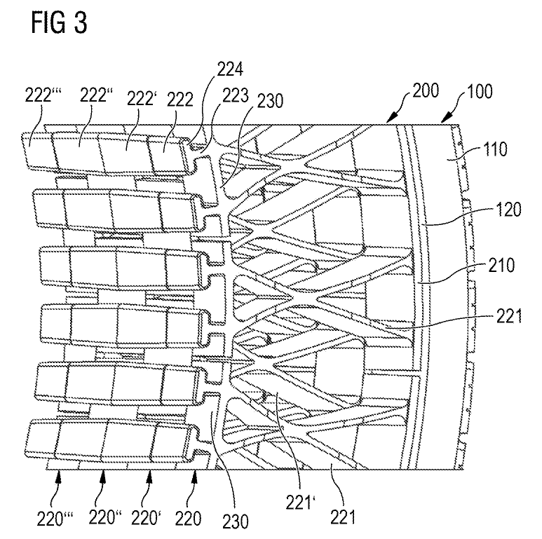

FIG. 3 shows a schematic perspective view of the supporting portion 200 and the tread band 100. Preferably, the tread band 100 comprises elastomer compositions, such as rubber compositions and is co-cured to the radially outer annular portion 210 of the supporting portion 200. In particular, the tread band 100 comprises a radially outer circumferential tread portion 110, herein comprising multiple tread blocks extending into a radially outer direction. Typically, the circumferential tread portion 110 is carried by a circumferential shearband 120, which is as such known to the person skilled in the art of non-pneumatic tires. Shearbands typically have a plurality of radially stacked circumferential layers, wherein multiple of such layers are cord reinforced (e.g., along the circumferential direction). Such layers typically comprise elastomer compositions, particularly rubber compositions, which are also known as such in the art and are not in the particular focus of the present invention.

The supporting portion 200 comprises in the present embodiment four axially adjacent circumferential rows of spokes 220, 220’, 220’’, and 220’’’. As shown in FIG. 3, a first row of spokes 220 comprises spokes 221, and another row of spokes 220’, which is axially adjacent the first row of spokes 220, comprises spokes 221’, which are circumferentially shifted in the present non-limiting embodiment. Furthermore, the spokes 221, 221’ extend from a radially outer annular portion 210 which is in the present case axially and circumferentially split. In this context, it is noted that the outer annular portion may also be integrally formed, or, e.g., as a continuous ring or band along the circumferential direction. Moreover, each row of spokes 220, 220’, 220’’, 220’’’ comprises a plurality of the radially inwards protruding anchoring portions 222, 222’, 222’’, 222’’’, wherein each of the anchoring portions 222, 222’, 222’’, 222’’’ comprises an anchoring head portion 224 and an anchoring neck portion 223, as already mentioned herein above. In the present embodiment, each anchoring neck portion 223 is carried by a radially inner circumferential and/or annular portion 230 of the supporting portion 200, which is, in the present embodiment, axially and circumferentially split. In other embodiments such a portion may be integrally formed, e.g., as a continuous ring or band along the circumferential direction.

As further visible in FIG. 3, the anchoring portions 222, 222’, 222’’, 222’’’ taper along the axial direction. In particular, a radial thickness and also a circumferential width of each anchoring portion 222, 222’, 222’’, 222’’’ taper along an axial direction. Especially, said radial thickness and width taper continuously between two axially adjacent anchoring portions 222, 222’ on one axial/lateral side of the supporting portion 200 and two axially adjacent anchoring portions 222’’, 222’’’ on an opposite axial/lateral side of the supporting portion 200, in the present case from an axial center and/or an equatorial plane of the non-pneumatic tire assembly in axially outer directions. Such a taper is also described in further detail with reference to FIGS. 4 and 5 herein below.

FIG. 4 shows a partial cut view of the non-pneumatic tire assembly 1 having the tread band 100, including the tread portion 110 and the shearband 120, supported by the supporting portion including four circumferential rows of spokes 200, 200’, 200’’, 200’’’, comprising spokes 221, 221’, 221’’, 221’’’ which comprise respective anchoring portions 222, 222’, 222’’, 222’’’. These anchoring portions 222, 222’, 222’’, 222’’’ are received in corresponding anchoring slots 322, 322’ of the hub portion, particularly in an annular and/or circumferentially outer portion 310 at a radially outer side of the hub portion. As visible in FIG. 4, the radial thicknesses of the anchoring portions 222’, 222 taper continuously from an axial center or center portion of the supporting portion in an axially outward direction. In the present example, the taper angle α is at about 1°. In other words, the angle between both elongated sides of the anchoring portion is about 1° in total. In particular, the radial thicknesses of the anchoring head portions of these anchoring portions 222’, 222 taper in said direction. In this context, a first row of spokes 220 is provided radially below a first shoulder portion of the tread portion 110 and/or tread band 100 and a second row of spokes 220’’’ is provided radially below a second shoulder portion of the tread portion 110 and/or tread band 100, which is axially opposite to the first shoulder portion. A third row of spokes 220’ is axially adjacent to the first row of spokes 220, and a fourth row of spokes 220’’ is axially adjacent the second row of spokes 220’’’ (and axially adjacent the third row of spokes 220’). In the present example, the anchoring portions 222, 222’ of the first and third row of spokes 220, 220’ are anchored in one anchoring slot 322 of the hub portion 300, particularly provided in a first lateral annular member 301 of the hub portion 300. Similarly, the anchoring portions 222’’, and 222’’’ of the second row of spokes 220’’’ and 220’’ are anchored in one anchoring slot 322’of the hub portion 300, particularly provided in a second lateral annular member 302 of the hub portion 300, which is axially mounted to the first lateral annular member 301. In particular, the slots 322 and 322’ are essentially aligned, particularly in the axial direction. The construction of the hub portion 300 comprising axially split annular members 301, 302 is further illustrated and described with reference to FIG. 6 herein below.

FIG. 5 shows another schematic partial perspective view, in which parts of the supporting portion 200 and the tread band 100 are shown. FIG. 5 utilizes the same reference signs as the previous Figures, where appropriate. As shown by the convergent dashed lines, the circumferential width of the anchoring portions 222’’, 222’’’ tapers along the axial direction with the angle β, which is in the present case about 2°. The tapers described with reference to FIGS. 3 to 5 provide a plurality of advantages. For instance, they allow easier manufacturing of the anchoring portions, particularly with regards to demolding the anchoring portions, which typically comprise polymer compositions. Another advantage is the easier mounting of the spokes’ anchoring portions in the anchoring slots. Yet another advantage consists in an option of allowing an interference fit (which can, e.g., be achieved during mounting the anchoring portion in the anchoring slots) between the anchoring portions (particularly the anchoring heads) and the anchoring slots (particularly the anchoring head receiving portions of the slots).

FIG. 6 shows a schematic partial perspective view of the hub portion 300, which can also be mentioned as rim portion herein, comprising two axially adjacent annular members 301, 302, which are axially mounted to each other. Each annular member comprises a radially outer annular flange portion 313, and 313’, respectively. In this context, it is noted that such flange portions are not necessarily required in the present embodiment as the slots 322, 322’ of the flange portions anyhow taper in axially outer directions, thereby avoiding a loss of spokes, or their anchoring portions, in a radially outer direction. However, such flange portions 313, 313’ may also help to avoid intrusion of debris into anchoring slots 322, 322’ and/or the interface between the anchoring slots 322, 322’ and corresponding anchoring portions. In particular, the anchoring slots are provided in a radially outer annular and/or circumferential portion 310 of the hub portion 300. Preferably, both annular members 301, 302 are axially mountable and/or connectable to each other by a plurality of screw connections 340 provided along a circumferential direction of the hub portion 300. Moreover, a radially inner portion 350 of the hub portion 300 comprises a plurality of openings/holes 330 extending through the inner portion 350 such as for receiving one or more of bolts and screws for mounting the non-pneumatic tire assembly to a vehicle, such as a passenger car or truck (not shown).

FIG. 7 shows another schematic partial sideview of a supporting portion 1200 carrying a tread band 1100 according to another embodiment of the present invention. In particular, the tread band 1100 comprises a radially outer circumferential tread portion 1110 and a radially inner circumferential shearband 1120 which may for instance be the same or similar as already described herein above. The circumferential supporting structure or portion 1200 comprises a radially outer annular portion 1210, rows of spokes 1220 comprising X-shaped spokes 1221. In the present embodiment, each of the spokes 1221 comprises a pair of radially inner legs and a pair of radially outer legs connected by a connecting portion, and wherein each of the radially inner legs of a spoke 1221 comprises an anchoring portion 1222 comprising an anchoring head portion 1224 and an anchoring neck portion 1223. Different from the previously mentioned embodiments, the present embodiment does not comprise a radially inner annular portion connecting at least two anchoring portions with one another. In the present embodiment of FIG. 7, each radially inner leg of the spokes has an individual anchoring portion integrally formed with only one of the radially inner legs of the spokes radially below the connecting portion of the spoke.

It is emphasized that multiple embodiments, aspects, and/or features thereof can be combined with one another. Moreover, embodiments and/or features of one aspect can be embodiments and/or features of another aspect of the invention. Merely for the sake of conciseness such combinations have not been reiterated in their entirety herein.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A non-pneumatic tire assembly comprising:
a radially outer circumferential tread band;
a radially inner circumferential hub portion;
a circumferential supporting portion circumferentially supporting a radially inner side of the circumferential tread band on the circumferential hub portion, wherein the circumferential supporting portion comprises
a radially outer annular portion,
at least one circumferential row of spokes, extending from the radially outer annular portion to the radially inner circumferential hub portion, and comprising a plurality of radially inwards protruding and axially extending anchoring portions provided along a circumferential direction of the tire assembly; wherein
the circumferential hub portion has a plurality of axially extending anchoring slots provided on its radially outer side along the circumferential direction for axially receiving the radially protruding and axially extending anchoring portions and locking the anchoring portions against movement in a radial direction of the tire assembly, and
wherein at least one of the anchoring portions has a neck portion and an anchoring head portion wherein the neck portion is circumferentially narrower than the anchoring head portion, and
at least one of the anchoring slots has a neck receiving portion and an anchoring head receiving portion, and
wherein at least one of i) a radial thickness and ii) a circumferential width of the anchoring head portion and of the anchoring head receiving portion tapers along the axial direction.

2. The non-pneumatic tire assembly according to claim 1, wherein the radial thickness and the circumferential width of the anchoring head portion and of the anchoring head receiving portion taper along the axial direction.

3. The non-pneumatic tire assembly according to claim 1, wherein the anchoring head portion is axially received in the anchoring head receiving portion via an interference fit.

4. The non-pneumatic tire assembly according to claim 1, wherein each spoke comprises one or more legs and wherein each of the one or more legs comprises at its radially inner side one of the anchoring portions.

5. The non-pneumatic tire assembly according to claim 1,
wherein the tread band comprises elastomer compositions and one or more of the radially outer annular portion, the rows of the spokes, and the radially inner hub portion comprise one or more polymer compositions, and
wherein the radially outer annular portion of the supporting portion is connected to the tread band by one of curing, co-curing, and an adhesive.

6. The non-pneumatic tire assembly according to claim 1, wherein each of the spokes has essentially an X-shape, in a plane perpendicular to an axial direction of the tire assembly, having two radially outer legs and two radially inner legs, and wherein each of the two radially inner legs has an integrally formed anchoring portion which is separate from the anchoring portion of another leg of the two radially inner legs.

7. A non-pneumatic tire assembly comprising:
a radially outer circumferential tread band;
a radially inner circumferential hub portion; and
a circumferential supporting portion circumferentially supporting a radially inner side of the circumferential tread band on the circumferential hub portion, wherein the circumferential supporting portion comprises
a radially outer annular portion,
at least two axially neighboring circumferential rows of spokes, wherein each row of the circumferential rows of spokes extends from the radially outer annular portion to the radially inner circumferential hub portion, and comprises a plurality of radially inwards protruding and axially extending anchoring portions provided along a circumferential direction; wherein
the circumferential hub portion has a plurality of axially extending anchoring slots provided on its radially outer side along the circumferential direction for axially receiving the radially protruding and axially extending anchoring portions and locking the anchoring portions against movement in a radial direction of the tire assembly, and
wherein at least one of the anchoring portions and at least one of the anchoring slots taper along an axial direction so that an anchoring portion tapering along the axial direction is received in a respective tapering anchoring slot.

8. The non-pneumatic tire assembly according to claim 7,
wherein at least a majority of the anchoring portions and at least a majority of the anchoring slots taper along an axial direction so that the anchoring portions tapering along the axial direction are received in respective tapering anchoring slots, with one or more of:
i. each anchoring portion of the majority of anchoring portions having a neck portion and an anchoring head portion, wherein a radial height of the anchoring head portion tapers along the axial direction, and each anchoring slot of the majority of anchoring slots having a neck receiving portion and an anchoring head receiving portion, and wherein a radial height of the anchoring head receiving portion tapers along the axial direction so as to axially receive the anchoring head portion having the radial height tapering along the axial direction; and
ii. each anchoring portion of the majority of anchoring portions having a neck portion and an anchoring head portion, and each anchoring slot of the majority of anchoring slots having a neck receiving portion and an anchoring head receiving portion, and wherein a circumferential width of the anchoring head receiving portion tapers along the axial direction so as to axially receive the anchoring head portion having the circumferential width tapering along the axial direction.

9. The non-pneumatic tire assembly according to claim 7, wherein the circumferential rows of spokes comprise
a first circumferential row of spokes with anchoring portions tapering in a first axial orientation; and
a second circumferential row of spokes with anchoring portions tapering in a second axial orientation which is opposite to the first axial orientation.

10. The non-pneumatic tire assembly according to claim 7, comprising at least four of the circumferential rows of spokes, comprising a first circumferential row of spokes radially below a first circumferential shoulder portion of the tread band and a second row of spokes radially below a second circumferential shoulder portion of the tread band, which is axially opposite to the first circumferential shoulder portion, and wherein a third row of spokes is provided axially adjacent and inwards the first row of spokes and a fourth row of spokes is axially adjacent and inwards the second row of spokes.

11. The non-pneumatic tire assembly according to claim 10, wherein the anchoring portions of first row of spokes and the anchoring portions of the third row of spokes are aligned along the axial direction, and wherein the anchoring portions of the second row of spokes and the anchoring portions of the fourth row of spokes are aligned along the axial direction.

12. The non-pneumatic tire assembly according to claim 11, wherein the anchoring portions of the third row of spokes taper in an axially outer orientation from a first circumferential width to a second circumferential width which is smaller than the first circumferential width and wherein the anchoring portions of the first row of spokes taper in an axially outer orientation from a third circumferential width which is the same as or smaller than the second circumferential width, to a fourth circumferential width which is smaller than the third circumferential width.

13. The non-pneumatic tire assembly according to claim 12, wherein axially adjacent anchoring portions of the first row of spokes and anchoring portions of the third row of spokes have a circumferential width tapering continuously from the third row of spokes to the first row of spokes along the axial direction.

14. The non-pneumatic tire assembly according to claim 12, wherein the radially inner hub portion comprises a first annular member and a second annular member axially detachably mounted to the first annular member, wherein the first annular member comprises an anchoring slot tapering in a first axial orientation, for axially receiving the anchoring portions of the first row of spokes and the third row of spokes; and wherein the second annular member comprises an anchoring slot tapering in a second axial orientation opposite to the first axial orientation, for axially receiving the anchoring portions of the second row of spokes and the fourth row of spokes.

15. The non-pneumatic tire assembly according to claim 7, wherein each of the circumferential rows of spokes has from 20 to 200 anchoring portions.

16. The non-pneumatic tire assembly according to claim 7, wherein each anchoring portion tapers with an angle within a range of 0.25° and 10°.

17. The non-pneumatic tire assembly according to claim 7, wherein the tire assembly has from 4 to 8 rows of axially adjacent spokes.

18. The non-pneumatic tire assembly according to claim 7, wherein the spokes have essentially an X-shape, in a plane perpendicular to an axis of rotation of the tire assembly.

19. A non-pneumatic tire assembly comprising:
a radially outer circumferential tread band comprising one or more elastomer compositions;
a radially inner circumferential hub portion; and
a circumferential supporting portion circumferentially supporting a radially inner side of the circumferential tread band on the radially inner circumferential hub portion, wherein the circumferential supporting portion comprises
a radially outer annular portion,
at least four circumferential rows of spokes comprising one or more polymer compositions, the circumferential rows of spokes comprising
a first circumferential row of spokes radially below a first circumferential shoulder portion of the tread band,
a second row of spokes radially below a second circumferential shoulder portion of the tread band, which is axially opposite to the first circumferential shoulder portion,
a third row of spokes axially adjacent and inwards the first row of spokes, and
a fourth row of spokes axially adjacent and inwards the second row of spokes, and
wherein each row of the circumferential rows of spokes extends from the radially outer annular portion to the radially inner circumferential hub portion, and comprises a plurality of radially inwards protruding and axially extending anchoring portions provided along a circumferential direction;
wherein the radially inner circumferential hub portion has a plurality of axially extending anchoring slots, provided on its radially outer side along the circumferential direction, for axially receiving and locking the anchoring portions against movement in a radial direction of the tire assembly,
wherein each of the anchoring portions tapers along an axial direction and each of the anchoring slots tapers along the axial direction to complementarily receive a respective tapering anchoring portion,
wherein axially adjacent anchoring portions of the first row of spokes and of the third row of spokes taper continuously from the third row of spokes to the first row of spokes along the axial direction in a first axial orientation, and
wherein axially adjacent anchoring portions of the fourth row of spokes and of the second row of spokes taper continuously from the fourth row of spokes to the second row of spokes along the axial direction in a second axial orientation opposite to the first axial orientation.

20. The non-pneumatic tire assembly according to claim 19, wherein each of the anchoring portions is axially received in a respective anchoring slot via an interference fit.
